(19) United States
(12) Patent Application Publication
(10) Pub. No.: US 2016/0249187 A1
(43) Pub. Date: Aug. 25, 2016

(54) INSTANT MESSAGING SYSTEM

(71) Applicant: William Drew CURRY, Victoria (CA)

(72) Inventor: William Drew CURRY, Victoria (CA)

(21) Appl. No.: 15/046,658

(22) Filed: Feb. 18, 2016

Related U.S. Application Data
(60) Provisional application No. 62/118,154, filed on Feb. 19, 2015.

(51) Int. Cl. H04W 4/12

(52) U.S. Cl. CPC H04W 4/12

(57) ABSTRACT

An instant messaging system having a messaging server that provides a buffering gateway through which all instant messages must pass in order to reach a user. The buffering gateway has a lookup table with criterion specified by the user. The messaging server allows only those instant messages to pass through the buffering gateway that meet the criterion in the lookup table specified by the user.

### FIELD

The present application relates to an instant messaging system for smartphones.

### BACKGROUND

Technology imposes two polar-opposite pressures on people. The growing intrusion of an internet-connected presence in all walks of life versus the need to protect the sanctity of direct access to a person's smartphone. The smartphone has become the main point of contact for most people and as such is the focal point of risk management.

Instant messaging is arguably the world's leading smartphone application category, with every active smartphone containing at least one, and generally multiple ways to connect via text messaging services. The primary methods utilize the hardware provided by the smartphone's service provider in conjunction with the basic operations found within pre-installed apps. These are tied directly to the unit's primary identification, the phone number. This phone number allows direct texting even if both users have differing messaging services, and often at a price dictated by retail markets.

Most secondary messaging apps tie directly into a person's phone number to provide a user account that is controlled by the app provider, and allows anyone who knows the user's phone number to connect to that user, provided both use the same app. This is the standard method of operation for most messaging apps.

A small group of messaging apps allow the point of contact to be a user-derived username, tied in the background to the phone number. This allows users within the same app to connect via a username.

The one pertinent fact central to messaging apps is that at their core, the controlling point of access to a user is through the user's account. This is the overarching control mechanism for each such app. By giving a growing number of people one's phone number or username, a person's privacy can be easily compromised.

Whenever a breach of security occurs through one's smartphone, further repercussions can occur. There is little to stop any malicious person from sharing one's phone number or user account, which could cause a person significant problems. Typical methods of blocking users or phone numbers are easily circumvented and nothing stops a malicious person from sharing one's phone number or user account with others. Also, the act of recreating user accounts or changing phone numbers is time-consuming and costly. Entire businesses have been created to help people better manage this need to change phone numbers.

Currently, the only method of security is to limit distribution of your phone number or user account, which is not feasible with the growing need for direct communication. Risks in this regard include, but are not limited to, items in the following list;

Risk Factors Tied to Revealing Personally Identifiable Information.

1. Distributing your phone number or user account to somebody who ultimately has malicious intent.

2. Emerging conventions with dating, both in-person and online, demonstrate that the first level of a potential relationship is the sharing of connection details, to allow for instant messaging to help grow the relationship. Arguably, a large percentage of relationships fail, and a romance seeker is left with having their connection details widely distributed which may subsequently be regrettable or risky for numerous reasons. Just ask anyone who has received a late-night text from an old connection at just the wrong time.

3. As classified advertisements in newspapers lose ground to online services for ease of selling personal or other goods, each connection made in this new environment poses risks. Often the only useful means of ensuring a meeting between strangers is via instant messaging and thus connection details are exchanged. This emerging societal behaviour poses significant risks, as many predatorily-oriented individuals are aware of this new gateway to opportunity for malicious activity.

4. The use of public bulletin boards offers well-known risk for posting connection details, especially for observant predators who watch for potential victims as they post notices. There are multitudes of such examples of risk factors with connections into one's smartphone, each unique and each posing potential life-altering consequences.

In the context of an increasingly connected world, it is clear that the nature of how people protect their smartphone or identity needs to be addressed. This is currently just not possible in a way that is practical or makes sense, and is certainly not part of the expedient world that technology is pushing to the forefront. This is subject of the application platform.

### SUMMARY

There is provided an instant messaging system having a messaging server that provides a buffering gateway through which all instant messages must pass in order to reach a user. The buffering gateway has a lookup table with criterion specified by the user. The messaging server allows only those instant messages to pass through the buffering gateway that meet the criterion in the lookup table specified by the user.

If the user wishes to have identify-free “cloaked” or anonymous communication, the lookup table may contain one or more aliases of the user. The buffering gateway would then allow messages to pass through to a user only if a correct alias is entered which matches one of the aliases of the user. This allows the user to establish an instant messaging connection without exchanging user messaging account information or personal information.

If the user wishes to ensure communication comes only from persons he or she “authorizes”, the lookup table would contain both a username (whether an alias or an authentic name) and an alphanumeric key. The buffering gateway would then allow messages to pass through to a user only if a correct username and a correct alphanumeric key were entered which match the username and the alphanumeric key of the user.

If the user is part of the “singles” scene and wishes to entertain “expressions of interest” from potential suitors, the lookup table would contain physical attributes of the user. The buffering gateway would then allow messages to pass through to the user only if the message was sent from a smartphone located within a pre-determined distance to a smartphone of the user and only if physical attributes are specified which match the physical attributes of the user as contained in the lookup table.

The buffering gateway contains a further feature. The buffering gateway has a mutable dictionary that associates a transient key with each message sent by a sender to a smartphone of a recipient. When the buffering gateway updates the mutable dictionary upon command of the sender, it “refreshes” the smartphone of the recipient to delete a selected message previously sent by the sender or update and revise a selected message previously sent by the sender.

As will hereinafter be further described, this application enables instant messaging users to connect and communicate via transitory aliases known as cloaked profiles. It does this without requiring the exchange of any personally identifiable information, and further, to allow each connection to be completely transient in nature, allowing one user to sever all ties with another user, forever, as part of the standard usage of the application. Further, no changes to the user's own account are required to manage this severing action as the cloaked profile is the only point of contact for any other user. It will do so while entirely hiding the complexity of the cloaked connection and yet enable instant messaging exactly as users are accustomed to.

There will be built-in flexibility to allow for zero or more special keys to be required for a new connection, each of which will enable increasing levels of protection, allowing only desired connections to exist. The allowance for zero keys will allow public services such as information tip-lines to use the application in an efficient manner. The use of one special key to connect with a cloaked profile will be the standard behaviour as this renders the likelihood of any random connection highly unlikely.

To mitigate issues raised in the Background section, this application will create a new paradigm: Identify-Free Cloaked Instant Messaging. Anonymity, and thus cloaking, in the context of instant messaging apps can be defined by the following levels:

Levels of Instant Messaging Application Anonymity.

1. Zero-Anonymity: a messaging app that uses identifiable means from real-world information about a user to allow others to connect to that user's account, for example a phone number or email address. Typically one may connect to another account without using the same app, for example standard Short Messaging Service (SMS) messaging.

2. Partial-Anonymity: a messaging app that allows a user to create an account with a fictitious username, and allows others to connect via that username. This is the category of many websites, but few apps.

3. Complete-Anonymity (aka Cloaked): a messaging app that allows for a user to connect to another user without exchanging any personally identifiable information, and further, all connection details are easily deleted, completely removing any reconnection attempt.

From Wikipedia: “A cloaking device is a theoretical or fictional stealth technology that can cause objects, such as spaceships or individuals, to be partially or wholly invisible to parts of the electromagnetic (EM) spectrum. However, over the entire spectrum, a cloaked object scatters more than an uncloaked object. Fictional cloaking devices have been used as plot devices in various media for many years.”

This application will address all risks outlined in the Background section by creating a smartphone instant messaging platform that removes the user account completely from any level of connection to the outside world. It will incorporate a cloaked Messaging Connectivity Algorithm (CMCA) that entirely protects a user's identity. Further, no personally identifiable information is required of the user to install and use the app, furthering the sanctity of the user's smartphone and safety.

This application creates an entirely new subcategory of instant messaging. It takes a radical departure from the accepted approach of all such apps, because a user's account is never employed to connect to other users. As such the design deserves patent protection. The application is entirely practical and useful, and permits a person's smartphone number and account information to be entirely protected. The system is not obvious because no messaging app uses a CMCA-oriented approach to control access to another user. It is an original and innovative concept, worthy of protection.

This cloaked instant messaging application is a complete restructuring of how to manage users and their connection to each other, allowing people to connect without ever having to reveal any personally identifiable information, including their phone number. Once this connection is established, the app will function in a manner identical to regular instant messaging applications, as all technical complexities work in the background and are hidden from the user. Essentially this connection is established utilizing only a cloaked profile name, in conjunction with a transient key. This method of connection via identify-free, transitory, and virtualized endpoints currently does not exist and, therefore, provides unparalleled privacy to all app users.

It is the intent of this patent application to protect this new, very useful and non-obvious evolution in instant messaging for smartphones for every possible derivation of identify-free cloaked-styled instant messaging, or any app that comprises a portion thereof.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a schematic overview of a method of instant messaging.

FIG. 2A through FIG. 2E are a series of sequential screen shots from the point of view of a person making a chat request using a username and alphanumeric key.

FIG. 3A through FIG. 3D are a series of sequential screen shots from the point of view of a person receiving an incoming chat request.

FIG. 4A through FIG. 4C are a series of sequential screen shots from the point of view of the person who made the chat request.

FIG. 5A through FIG. 5F are a series of sequential screen shots of a user revising a message sent with typographical errors.

FIG. 6A through FIG. 6F are a series of sequential screen shots of a user deleting a message.

FIG. 7A through FIG. 7F are a series of sequential screens shots of a user sending a chat request to a person in the same location having specified physical characteristics.

### DETAILED DESCRIPTION

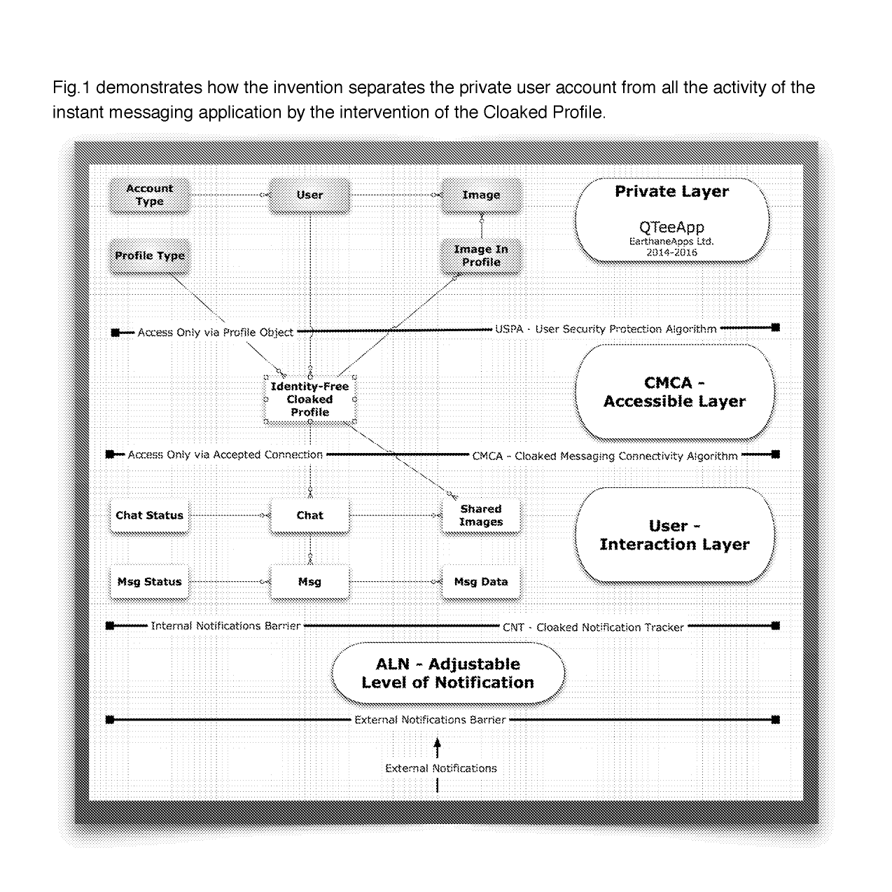

A method of instant messaging will now be described with reference to FIG. 1 through 7F.

Referring to FIG. 1, there is illustrated an overview of this method of instant messaging. The key to understanding FIG. 1 is the CMCA-Accessible Layer. This is the area that controls all access within the app for data flow. It is a buffering gateway in the server for any access to the Private Layer, where actual user account details exist. There is simply no method for a user to access another user's details. Every connection request, every sent message, every image shared, every possible type of note will only ever be delivered to the proxy cloaked profile, which effectively anonymizes the interaction. Access to this cloaked profile is only allowed through the CMCA. Thus, even getting to this proxy is controlled. All other elements of the app are redesigned components that exist in one form or another with various other messaging applications. It is this innovative restructuring that is key to the patentability of this process, as it is new, not obvious and very useful.

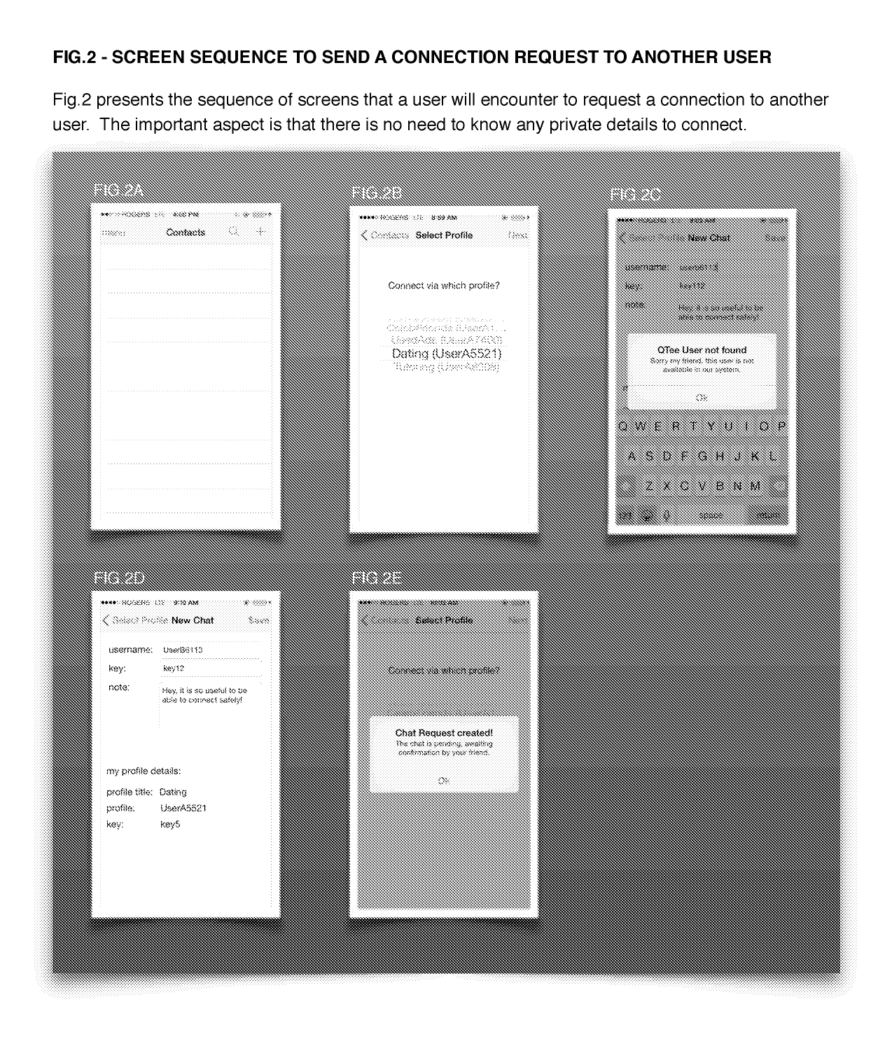

FIG. 2 presents the sequence of screens that a user will encounter to request a connection to another user. The important aspect here is that there is no need to know any private details of the other user to connect. This sequence is showing how UserA sends a connection request to UserB.

FIG. 2A—For demonstration purposes, we show an empty Contacts list. UserA has no connections to any other user within the system. In order to start a new connection request, UserA will tap the standard icon, the “+”, in the upper right corner.

FIG. 2B—The next step in connecting is to decide which cloaked profile to connect with (as the user may have multiple profiles). This screen shows a standard approach at selecting from a pre-existing list of items. Once selected, UserA taps the “Next” button.

FIG. 2C—To create the connection, the only information UserA requires is a valid cloaked profile name and its' currently valid key, both of which were given by UserB in one of many scenarios where UserB would like to protect personally identifiable information. This screen shows an attempt to connect with either incorrect information or if UserB has blocked UserA.

This particular screen forms the heart of the interaction with the CMCA. This is where a user can send a request through the protective layer into the cloaked profile datastore, seeking an exact match to the inputted details. No suggestions or close matches are returned, only the exact match to both the cloaked profile name and the key. UserA may also include a comment to help UserB understand who is trying to connect to them, given that the inbound profile is cloaked. UserA could easily create a cloaked profile name that helps UserB know who is requesting a connection, but it is not a requirement of the system.

An additional layer of security is present in that if a user has blocked another cloaked profile, even if an exact match is found, it is not returned. It will be as if the requested profile does not exist. There are variations to this that may be deployed, such as returning a gentle message suggesting the requesting user move on, etc., as this may help reduce frustration from users thinking the system is just not working. This application reserves the right to variations on this style of returned message.

FIG. 2D—This screen shows UserA having entered proper connection information for UserB. Information is also provided on this screen to remind UserA which cloaked profile will be sent to UserB, who will see only that UserA5521 is trying to connect, plus the note. The cloaked profile Title is a “user friendly” (easy to remember) name for use by UserA only. And note that the key to UserA's profile is not required by UserB since UserA is initiating the request to connect. The next step is to tap the Save button, which may also be labelled as “Send”, “Connect”, “Request” or any variation that promotes understanding of the intent to send the connection request.

FIG. 2E—This screen shows the acknowledgement of the sent request. User A can now return to the Contacts screen and filter for “Pending Requests Sent” to see this request. The system will automatically notify UserA once UserB accepts the request. Should UserB reject the request, no notice is sent out, the request just disappears. There will be back-end system variations to this to send out a notification to help users understand the process better should feedback suggest this is needed. These types of system changes will be hidden away from all app users, and will changeable on the fly within the central codebase running on the servers.

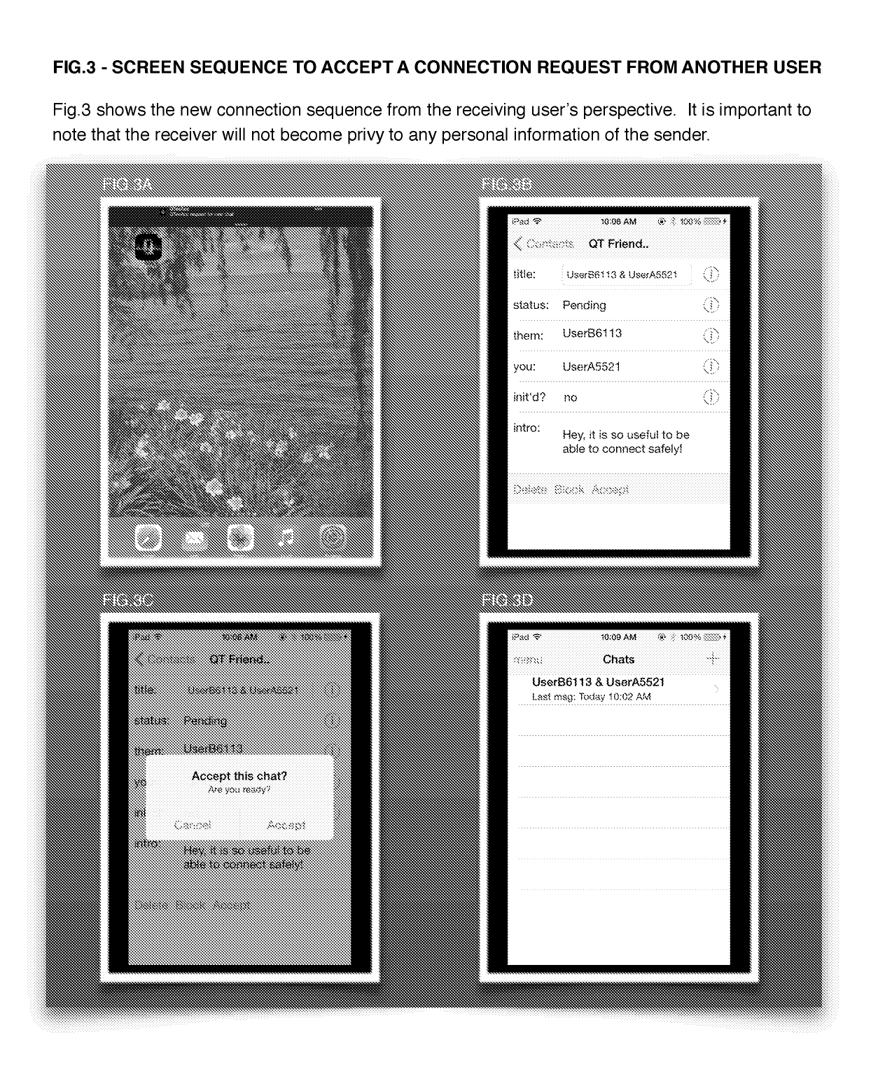

FIG. 3 shows the new connection sequence from the receiving user's perspective. It is important to note that the receiver will not become privy to any personal information of the sender.

FIG. 3A—UserB is shown using the app on an iPad, and receiving a notification that a user has requested a new connection. If UserB taps this notification, the app will open directly to the screen that manages this new request (shown in FIG. 3B). Internal to the app will be a listing of notifications like this that are waiting to be acted on, as a simple “todo” list for the convenience of the user.

FIG. 3B—This screen shows the pertinent information for managing the inbound connection request. The app offers a simple name for the connection by joining both profile names, always in the form of [local profile name] & [remote profile name]. This is intended to help users who manage multiple profiles. This can be changed either now or later if UserB wants something more meaningful. This will not impact UserA's connection details in any way. Features of the app will be implemented to display contacts by profile to further help users with the app, because of the increased functionality provided by this application, and not available in other instant messaging applications.

UserB has the ability to delete the request, which would allow UserA to send another at a later date if desired. UserB may also Block the request which would forever stop any attempt to connect to this cloaked profile. A point of interest: if UserB simply deletes the request and changes the profile's key, UserA will also never be able to connect again since both pieces of information are essential to connect.

FIG. 3C—This screen shows the prompt the app will offer if UserA taps the Accept button. One final moment to ensure this is what is desired before the app sends a note through the CMCA layer to create the proper connections between UserA and UserB, all without any personally identifiable information being shared between UserA and UserB. If the user subsequently changes their mind they can simply delete or block the connection.

FIG. 3D—This screen shows the new connection, known as a contact, now available to both UserA and UserB on their respective Chats view. The bolded name shown in the figure is the app-suggested name and, if changed by the user, that new name will be displayed here. It is important to understand that each contact need not have an active chat but each chat will have an existing contact. Some chats may simply become inactive for any number of reasons. If so, a user may use standard mobile app techniques to remove them. In this case, a user can swipe the chat row to the left, revealing the delete button. If the chat is deleted, the actual contact is untouched, and an active chat can be created with an existing connection via the “+” button.

Following standards for mobile UI's, any chat with an unread message will show at the top of this Chats view, with a special icon to flag it as unread. The app will manage inbound messages, unread statuses, and all related tasks, mapping all such messages to cloaked profiles via the CNT (Cloaked Notification Tracker) (see FIG. 1), which integrates the CMCA and the ALN (Adjustable Level of Notification), which is an enhancement to notifications beyond standards, allowing more privacy. This is adjustable for each profile and for each connection. Thus if a user doesn't want to see any of the text of a message within a notification, this can be set as such, affording more privacy.

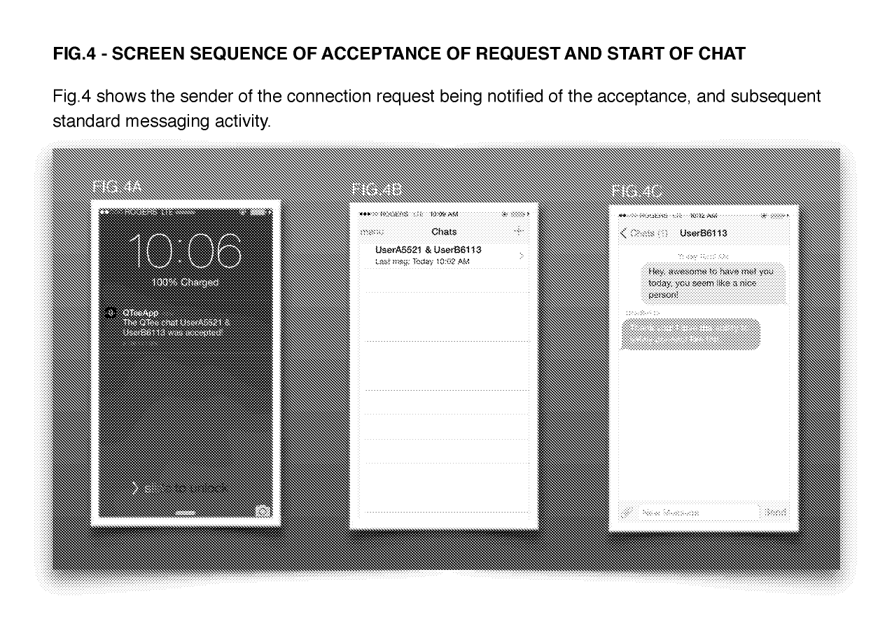

FIG. 4 shows the sender of the connection request being notified of the acceptance, and subsequent standard messaging activity.

FIG. 4A—The screen shows the notification sent to UserA that UserB has accepted the connection request. If UserA activates the notification, the app will work with the CMCA to ensure the correct active chat for the new contact with the cloaked profile in question is displayed (see FIG. 4B)

FIG. 4B—This screen mirrors FIG. 3D but with the name of the connection reversed to show the proper [local] & [remote] naming convention. By tapping the chat row, the app will activate the CMCA layer and display the current messages for this chat as per standards expected with today's instant messaging applications.

FIG. 4C—This screen shows the heart of the application. The ability to send instant messages to another user, without ever having shared any personally identifiable information. This is the dawn of a new era in privacy, control and management of one's growing social presence.

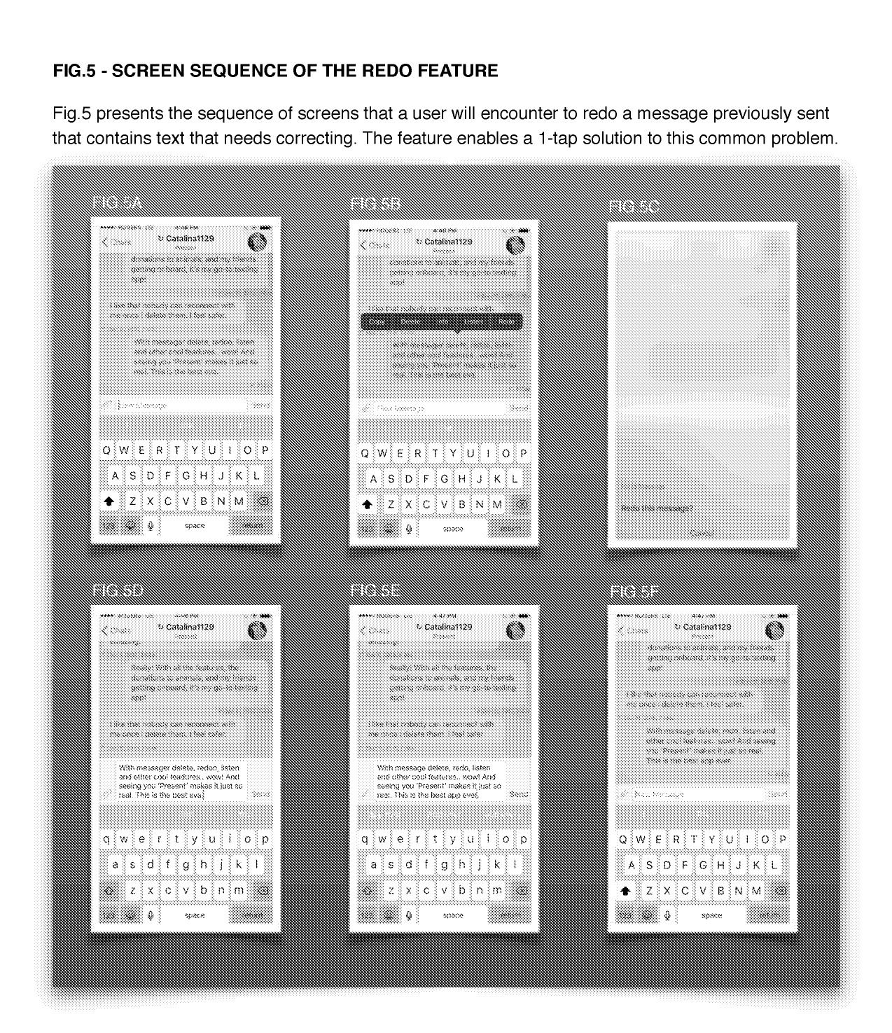

FIG. 5A is a screen shot that shows a sent message that contains errors: spellings of “redo” as “redoo”, “feature” as “feadures”, and “ever” as “eva”. The user decides to correct these mistakes. Instant messaging has created an entirely new paradigm of ways to send a message whose sole purpose is to correct mistakes in a prior message, which we dubbed as an “aftermessage”. This Redo feature can eliminate the need to create an aftermessage for any mistake made. QTeeApp also manages the previews of the most recent message shown in the Chats screen plus the read/unread state of the app based on the Redo feature. For example. If the message that is corrected has changed within the initial length of the message that appears on the message preview, the new corrected message will show properly in the new preview. As well, if the message was the only unread message awaiting the recipient, during the phase where the corrected message is not yet sent, there will be no Unread Messages indicator showing for the particular chat in question until the message is resent. If there were other unread messages then the indicator will not be impacted.

FIG. 5B is a screen shot of a longpress on the message that results in a popup with various options, one being the Redo feature. That feature is selected.

FIG. 5C is a screen shot of the confirmation to perform the Redo action. If confirmed, QTeeApp copies the text of the message, deletes the message off the cloaked server, notifies the recipient device to remove the message, and copies the text into the user's Send textbox. If there is existing text in the Send box prior to the Redo activation, QTeeApp will ask if it should replace that existing text, or append to it.

FIG. 5D is a screen shot of the errant text awaiting correction and resending by the user. This text is in draft mode and if the user backs out of the chat, it will be remembered for further editing upon return.

FIG. 5E is a screen shot of the errant text having been corrected to the user's satisfaction and the last step is to tap the Send button.

FIG. 5F is a screen shot that shows the recipient's message with corrections.

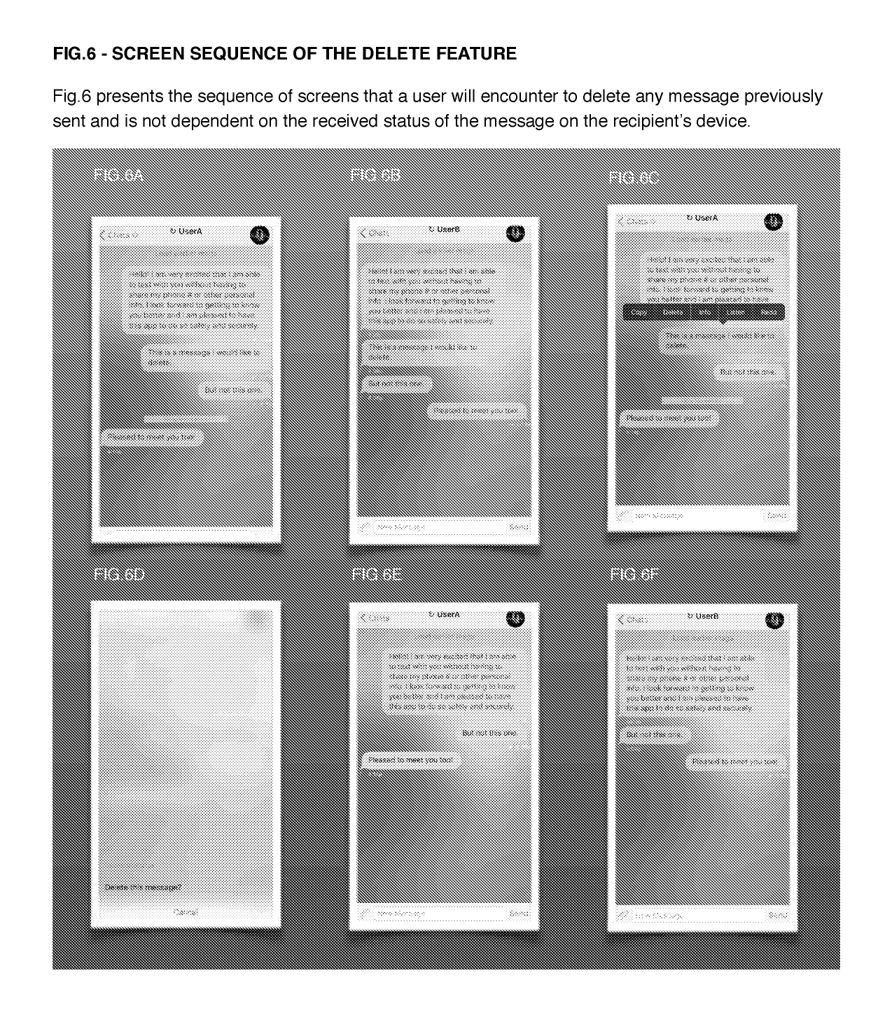

FIG. 6A is a screen shot that shows a typical chat in QTeeApp with one message that the user would like to delete (the second from the top message). Messages on the right are the messages sent from the local device. Each deleted message can impact the read/unread status of the recipient's QTeeApp messages. The Delete feature is responsible for managing this queue of messages, and ensures the “most recent message preview” is set to properly reflect the last sent message of the chat.

FIG. 6B is a screen shot of the same chat from the perspective of the other user, so the sides are reversed.

FIG. 6C is a screen shot showing the menu activated from the longpress of the message to be deleted, showing the Delete option which will be tapped.

FIG. 6D is a screen shot showing the request for confirmation of the delete request. Once tapped, QTeeApp flags the message to be deleted, and sends notifications to the other smartphone instructing it to remove the message immediately, even if it is being viewed. This works the same for pictures or text messages.

FIG. 6E is a screen shot showing the local side of the chat with the message deleted.

FIG. 6F is a screen shot showing the recipient's side of the chat with the message deleted.

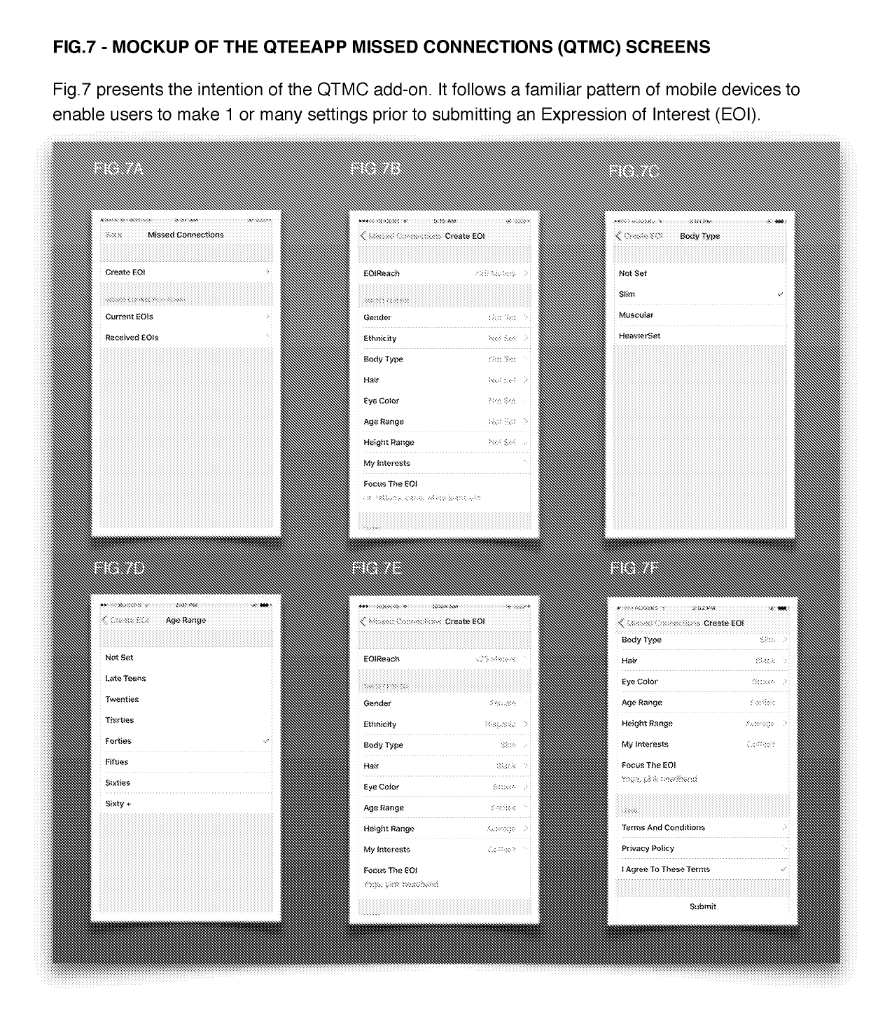

FIG. 7A is a screen shot that shows the main screen for management of Missed Communication's Expressions of Interest (EOI). It is here that a user can create new EOIs, explore new EOIs received from potentially interested QTeeApp users around them, as well as manage those they have created.

FIG. 7B is a screen shot of the creation of an EOI. Here you can see a portion of the options presented to a user to help them focus the EOI as best they can so that the target might receive it, provided they are an active EOI receiver.

FIG. 7C shows a detail screen for one attribute of the EOI. In this case Body Type is presented, giving the user the ability to select one particular attribute, or reset it to no selection.

FIG. 7D shows a detail screen for one attribute of the EOI. In this case Age Range is presented, giving the user the ability to select one particular attribute, or reset it to no selection.

FIG. 7E shows the main EOI creation screen with various attributes set, noting the ability to enter custom descriptors to handle unique cases that can truly isolate a particular user.

FIG. 7F shows the bottom of the EOI creation screen which includes the permissions that can help the user understand the usage of the QTMC add-on as well as the Submit button.

Each message that passes through the CMCA (Cloaked Messaging Connectivity Algorithm) is tracked and monitored. Each user will store a transient key that identifies both the message and the cloaked recipient, within a mutable dictionary. This dictionary is only available during app operation.

Both sides of a conversation hold reciprocal dictionaries, each indexed to the other's messages.

When a sender wishes to recall a sent message, he or she must register this intent with the CMCA. This is done by the sender selecting a previously sent message, performing a longpress action, and selecting either “Delete” or “Redo”. So long as the permissions are available to access the other chat, the CMCA will issue a command to update the status of the message then publish an internal command message that will be received only by the other chat's device. This command carries a payload within the notification that identifies the task at-hand, a message recall, plus the transient key of the chat and the exact message.

If the message is still available, it is removed from the mutable dictionary and the chat is forced to refresh itself, which effectively removes the message from the other side. This message can never be retrieved again by the other user.

If the command is to Redo the message, the app will take further actions by inserting the text of the message back into the Send textbox to allow the user to make changes to send again. It takes care to ask what to do if there is text already in the Send textbox prior to the Redo command, asking the user to overwrite or append the text of the message that was the subject of the Redo action.

Features and Benefits of the Application.

1. Completely protected user account, with no unauthorized access by other users.

2. Each user can create unlimited cloaked profiles, each protected by a special key, definable by the user, and changeable at any time.

3. Connect to other users only through cloaked profiles, with each cloaked profile acting in essence as the user's sole point of contact from the perspective of the other user.

4. Connect to as many or as few other users as desired within each cloaked profile.

5. An adjustable level of information in pop-up notifications, per profile and/or user.

6. No need for revealing one's phone number to the app, to another user or anyone, ever.

7. User account is completely secured from any level of accessibility from an outside user.

8. No random, unwanted or intrusive connections.

9. No user can find another user unless that other user has given them a cloaked profile name and key, both of which are transient and changeable.

10. A user can connect freely without worry of any future risks as no identifiable information is exchanged in order to connect.

11. At any moment, a user can disappear completely from another user, with no way to ever reconnect again.

12. No spam is possible.

13. A sent text can be deleted regardless if read or not by the recipient. If this deleted message was the last message of a chat, and featured in the chat's preview on the Chats screen, the preview is updated to ensure no remnant of the deleted message exists.

14. A sent textual message that contains errors can be corrected with a one tap action via a feature called Redo, which will delete the errant message, reset the user's Send textbox, await corrections, then allow the user to resend the message.

The Elements of the Application:

The User Security Protection Algorithm (USPA), which protects the actual user account, and has no ability to connect to any other user account. The USPA allows the user account to connect with its' own cloaked profiles, which completely protects the true and hidden user account from others. The USPA has no need for a user's phone number to manage connections or the application in general.

The Cloaked Messaging Connectivity Algorithm (CMCA) serves as a buffering gateway on the server. It has a lookup table, which enables the cloaked profile and locking key mechanism. This will enable the cloaked profile and locking key mechanism, and the protected connection between one cloaked profile and another. Each cloaked profile can then be connected to any number of cloaked profiles of other users.

The Adjustable Level of Notification (ALN), which controls how much information is displayed when a notification pops up, and will further enhance security to avoid accidental viewing of notifications by anyone near an idle smartphone. Examples of this would be if one profile was sensitive and a user preferred to never have it appear as a pop-up notification, or perhaps only the name of the profile (or its' alias) to appear, or perhaps finally the standard of a limited amount of the actual message.

The Cloaked Notification Tracker (CNT), which routes all inbound notifications from service providers like Apple to ensure that proper screens are presented to the user if the user acts on the notification. This is more complicated than typical instant messaging apps due to the cloaked nature of the unlimited profiles and the virtualization of all endpoints.

A fully functional instant messaging application that is fully compliant with the CMCA, USPA, ALN and CNT.

A User Interface (UI) Integrated into the CMCA, USPA, ALN and CNT:

1. Screen to create cloaked profiles with ease, in most cases with only a few taps.

2. Screen to search for a cloaked profile via profile name and key. This is not a filtering tool to find users, but a specific-profile search facility, if you do not know exactly the recipient's profile name and key, you will never find that profile. The possibility of randomly sending a connection request to another profile is incredibly remote.

3. Screens to manage various connected profiles; a task more complex due to a user's ability to have numerous cloaked profiles connected with numerous other cloaked profiles. The ability to delete or block other users is managed in a manner identical to regular instant messaging applications:

If a user simply deletes another connected profile, the deleted profile may later ask for a reconnection if desired. If instead the other profile is blocked, that blocked profile cannot subsequently request a reconnection. This will be adjustable internally to respond to user feedback as it may prove more user-friendly to indicate the user no longer wants further communication.

The CMCA will provide the ability to reach out and remove a sent text, and allow a user to Redo a message regardless if it was read or not by the recipient.

The application is assembled in accordance to best practices and the standards imposed by the various distribution sites, i.e. The Apple App Store.

Examples of the Application:

### Making an Identify-Free Cloaked Connection:

UserA and UserB both have QTeeApp on their smartphones.

Both users create cloaked profiles, each with a unique name and key. For example, UserA's cloaked profile may be “SmileyGirl” with a key of “happy”.

For one of a myriad of real-life reasons, UserA and UserB want to connect via QTeeApp.

UserA gives UserB the name of the profile and key she wants UserB to connect to.

UserB then:

1. Activates QTeeApp.

2. Accesses the Contacts screen.

3. Clicks the “+”.

4. Selects which cloaked profile to connect with.

5. Enters the details UserA provided, and optionally enters a greeting or personal note into the comment textbox.

6. UserB then taps the Connect button.

QTeeApp's CMCA API (Application Programming Interface) activates and seeks this cloaked profile. If the cloaked profile is not found, UserB is notified. If the exact profile is found, a connection request is created and sent to UserA.

UserA has the option to accept or refuse the request.

The cloaked connection is secured, both users are activated.

UserB gets a notice of acceptance of the connection request.

Both users now see the connection within their active contacts list.

Neither party had to reveal any personally identifiable details to make the connection, and now may interact in the same manner as with any modern instant messaging application.

### Removing a Cloaked Connection Forever:

UserA has decided UserB is no longer wanted as a connection.

UserA accesses the Contacts page, finds the connection with UserB and opens it.

UserA taps the block button.

UserB loses all connection to UserA, including all messages and content with UserA.

If UserB tries to reconnect with UserA, the CMCA notes the block, and informs UserB of the failure to find UserA's cloaked profile.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. An instant messaging system, comprising:
a messaging server having a buffering gateway through which all instant messages must pass in order to reach a user, the buffering gateway having a lookup table with criterion specified by the user, the messaging server allowing only those instant messages to pass through the buffering gateway that meet the criterion in the lookup table specified by the user.

2. The method of claim 1, wherein the lookup table contains one or more aliases of the user, the buffering gateway allowing messages to pass through to a user only if a correct alias is entered which matches one of the aliases of the user, the use of one or more aliases allowing the user to establish an instant messaging connection without exchanging user messaging account information or personal information.

3. The method of claim 1, wherein the lookup table contains usernames and alphanumeric keys, the buffering gateway allowing messages to pass through to a user only if a correct username and a correct alphanumeric key are entered which match the username and the alphanumeric key of the user.

4. The method of claim 1, wherein the lookup table contains physical attributes of the user, the buffering gateway allowing messages to pass through to the user only if the message is sent from a smartphone located within a pre-determined distance of a smartphone of the user and only if physical attributes are specified which match the physical attributes of the user as contained in the lookup table.

5. The method of claim 1, wherein the buffering gateway has a mutable dictionary that associates a transient key with each message sent by a sender to a smartphone of a recipient, the buffering gateway updating the mutable dictionary and refreshing the smartphone of the recipient upon command by the sender to delete a selected message previously sent by the sender or update and revise a selected message previously sent by the sender.
